(19) United States
(12) Patent Application Publication
(10) Pub. No.: US 2005/0134595 A1
(43) Pub. Date: Jun. 23, 2005

(54) Computer graphics display system

(76) Inventors: Hung-Ming Lin, Hsinchu City (TW); Ke-Ming Lin, Hsinchu City (TW); Peng-Hua Wang, Hsinchu City (TW)

Correspondence Address: RABIN & BERDO, P.C.;Suite 500, 1101 14th Street, N.W., Washington, DC, 20005, US

(21) Appl. No.: 10/898,164

(22) Filed: Jul. 26, 2004

Related U.S. Application Data
(60) Provisional application No. 60/530,266, filed on Dec. 18, 2003.

(51) Int. Cl. G06F 13/18; G09G 5/00

(52) U.S. Cl. 345/535

(57) ABSTRACT

A computer graphics display system contains a graphics processing unit. A graphics processing unit extracts the display information needed for executing graphics display from system memory via the north bridge according to the graphics display command from the CPU and then processes the display information. The display information is stored directly in the system memory so that the graphics processing unit can directly access the system memory without the use of a graphics buffer. This lowers the system cost.

### REFERENCE TO PROVISIONAL APPLICATION

This application claims priority under 35 USC § 119 (e) of applicants' copending Provisional Application Ser. No. 60/530,226, filed Dec. 18, 2003.

### BACKGROUND OF THE INVENTION

1. Field of Invention

The invention relates to a computer system and, in particular, to a computer graphics display system.

2. Related Art

The graphics processing unit inside a computer system plays a very important role. Its structure has been improving with the computer display technology. As shown in FIG. 1, the computer graphics display system includes a graphics processing unit (GPU) 10, a central processing unit (CPU) 20, a memory bridge 30 including a north bridge 32 and a south bridge 34, a system memory 40, an IO device 50, and a frame buffer 60. The GPU 10, the CPU 20, the system memory 40, and the IO device 50 are connected to the memory bridge 30. The GPU 10 receives data from the system memory 40 via the memory bridge 30. The GPU 10 exchanges data with the frame buffer 60 through a local data bus. The frame buffer 60 is used to store data into and out of the system memory. The GPU 10 follows commands from the CPU 20 to generate graphical data, which are then stored in the frame buffer 60 or shown on a display device.

When the CPU 20 processes a memory task, it processes the address information related to the task inside a virtual address space. The CPU turns a virtual address into a physical address for communicating with the north bridge 32. After the north bridge 32 receives the physical address, it determines whether the task is defined with a position in the address space (or PCI address space) of the system memory 40.

Once a physical address is received according to the GART address space, the north bridge 32 further converts that into a physical address using a GART table. The north bridge 32 then communicates with the system memory 40 and obtains the corresponding memory block (for example, memory row, or memory with 32-bit, 64-bit, or 128-bit multiple rows). If the physical address corresponds to the system memory 40, the north bridge 32 uses the physical address to simplify the mmeory task. For example, if the memory task is a reading task, the north bridge 32 simplifies the step of obtaining the corresponding memory row in the system memory 40 and provides it to the CPU 20 to use. If the physical address corresponds to the PCI address space, the north bridge 32 sends the task to the PCI bus.

The GPU 20 processes the graphical information. The graphical information processing requires a high-speed low-wait transmission path. The local frame buffer 60 is connected to the GPU 10 for storing part of the display data. Moreover, the frame buffer 60 further stroes information of texture data, temporary pixel data, or pixel depths. Normally, the GPU 10 exchanges informaiton with the frame buffer 60 via a local data bus. If the frame buffer does not contain any data, the GPU 10 executes the memory reading command in the system mmeory 40 along with the north bridge 32 via AGP bus.

The drawback of the system shown in FIG. 1 is that the graphics processor cannot access the system memory at a sufficiently fast speed. Therefore, the system is forced to use the local frame buffer to read data. The installation of the frame buffer does not only increase the cost, but also occupies space on the mainboard.

It is thus imperative to provide a computer graphics display system for the GPU to directly access the system memory, achieving the same effect for the graphics system while lowering the system cost.

### SUMMARY OF THE INVENTION

In view of the foregoing, the invention provides a computer graphics display system for the GPU to directly access the system memory, achieving the same effect for the graphics system while lowering the system cost.

To achieve the above objective, the invention provides a computer graphics display system that can directly store display information in the system memory. The computer graphics display system contains: a CPU; a GPU, which receives graphics display commands from the CPU and processes the graphics display information; a system memory, which stores all display information for graphics display; and a memory bridge, which is connected between the GPU and the system memory through a high-speed bus, as a channel for data transmissions between the CPU and the GPU. The memory bridge contains a north bridge connected to the GPU via the high-speed bus, controlling the data exchanges between the system memory and the GPU. The GPU extracts the display information required for executing graphics display from the system memory via the north bridge according to the graphics display command from the CPU, and then processes the display information.

The disclosed computer graphics display system directly stores the display information in the system memory without a local frame buffer, enabling the GPU to directly access the system memory. This saves the motherboard space and, at the same time, lowers the system cost.

### BRIEF DESCRIPTION OF THE DRAWINGS

The invention will become more fully understood from the detailed description given hereinbelow illustration only, and thus are not limitative of the present invention, and wherein:

FIG. 1 shows the module structure of a conventional graphics display system;

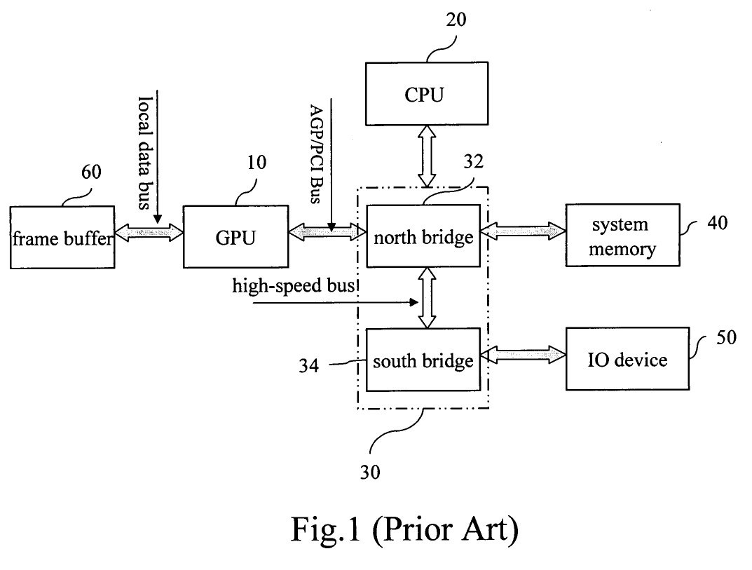

FIG. 2 shows the structure of the disclosed graphics display system;

FIG. 3 is a schematic view of the GPU and the north bridge according to the first embodiment of the invention; and

FIG. 4 is a schematic view of the GPU and the north bridge according to the second embodiment of the invention.

### DETAILED DESCRIPTION OF THE INVENTION

The chipset is the kernal part of a mainboard, functioning as a bridge between the CPU and peripheral devices. According to their positions on the mainboards, they can be divided into north bridge chips and south bridge chips. The north birdge chip provides supports for the types of the CPU, the primary frequency, the types and largest capacity of memory, and ISA/PCI/AGP slots, and ECC debugs. The south bridge chip provides supports for the keyboard controller (KBC), the real-time contrller (RTC), the universal serial bus (USB), the Ultra DMA/33(66) EIDE data transmissions, and the ACPI. The north bridge chip plays a dominant role and is thus called the host bridge.

In the prior art, the primary function of a local frame buffer is to provide a larger bandwidth for GPU to process data. The use of a high-speed bus enables the GPU to directly access data from the system memory. The invention removes the frame buffer, directly stores display data in the system memory, and uses the high-speed bus to transmit data.

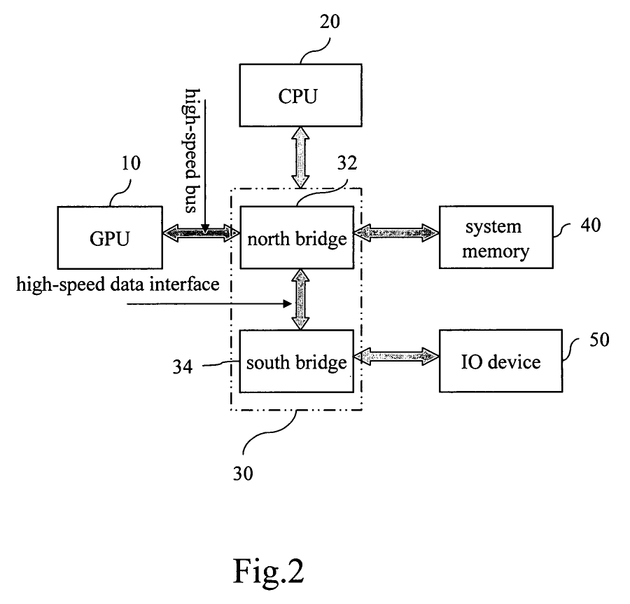

With reference to FIG. 2, the pixel data, texture data, temporary pixel data, and depth data for the GPU 10 to process graphics display are stored in the system memory 40. The GPU 10 communicates with the system memory 40 via the high-speed bus. The GPU 10 follows the graphics display command from the CPU 20 to extract from the system memory 40 the display information needed for executing graphics display and to process the display information. We describe in further detail the disclosed system:
(1) GPU 10. It receives a graphics display command from the CPU and locally executes graphics display operations according to the display command.
(2) CPU 20. It distributes the input graphics display command to the CPU for operations. It also provides a general control over the graphics display.
(3) System memory 40. It stores all display infomration for graphics display.
(4) Memory bridge 30. It is connected to the GPU and the system memory via a high-speed bus, providing a channel for data transmissions between the CPU and the GPU.It contains: a north bridge 32 and a south bridge 34. The north bridge 32 is a chip closest to the CPU 20. It is in charge of the communications with the CPU 20. It controls internal trasmissions of data in the system memory 40, the CPU 20 or the system memory 40. It connects to the GPU 10 via the high-speed bus and controls the data exchanges between the system memory 40 and the GPU 10. The south bridge 34 is a chip on the mainboard. It is mainly in charge of the controls of I/O interfaces and IDE devices. The north bridge 32 and the south bridge 34 are coupled through a high-speed data interface.
(5) I/O device 50. The I/O device 50 provides serial and parallel interfaces and the floppy disk driver control interface.

The invention uses a high-speed bus to transmit display infomration, so that the GPU 10 direcly access data from the system memory. Since human eyes are sensitive to display delays, the GPU 10 demands for a faster data transmission speed. Therefore, the display request has a higher priority than other requests.

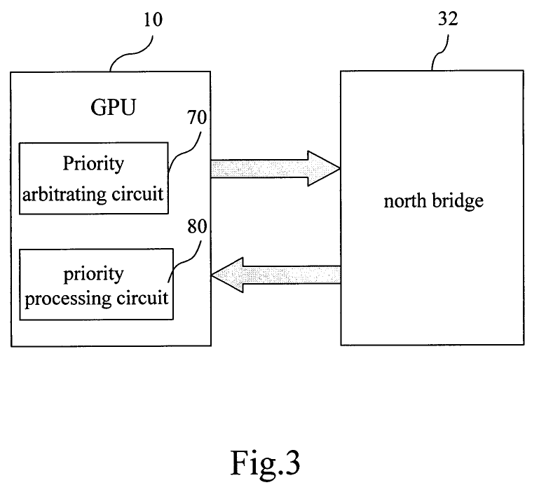

As shown in FIG. 3, the GPU 10 contains a priority arbitrating circuit 70 and apriority processing circuit 80. The priority arbitrating circuit 70 gives the display request the highest priority. The priority value is included inside the request data. For example, the request data contains one or several bits as the priority identification (ID). After processing the request, the value is returned to the GPU 10. When the GPU processes graphics, the priority processing circuit 80 extracts the priority value and processes it while the required data are returned from the north bridge. In the current embodiment, the priority processing circuit is inside the GPU 10. The north bridge 32 does not provide priority processing.

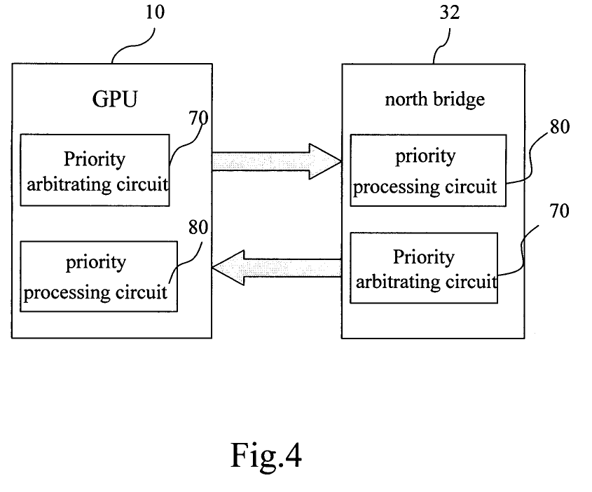

With reference to the second embodiment shown in FIG. 4, the north bridge 32 contains a priority processing circuit 80 and a priority arbitrating circuit 70. The priority arbitrating circuit 70 of the GPU 10 gives the display request the highest priority. The priority value is included inside the request data. For example, the request data contains one or several bits as the priority ID by protocol negotiation. After processing the request, the value is returned to the GPU 10. The priority processing circuit 80 in the north bridge 32 extracts the priority value and processes the request with the highest priority.

Certain variations would be apparent to those skilled in the art, which variations are considered within the spirit and scope of the claimed invention.

1. A computer graphics display system that directly stores display information in a system memory for a graphics processing unit (GPU) to directly access the system memory, the computer graphics display system comprising:
a central processing unti (CPU), which sends out a graphics display command and executes general control of graphics display;
a graphics processing unit (GPU), which receives the graphics display command from the CPU and executes graphics display operations according to the graphics display command;
a system memory, which stores all display ifnromation for graphics display; and
a memory bridge, which is connected to the GPU and the system memory via a high-speed bus, providing a data transmission channel between the CPU and the GPU, the memory bridge containing:
a north bridge, which is connected to the GPU via the high-speed bus and controls the data exchanges between the system memory and the GPU;
wherein the GPU extracts the display information necessary fro executing graphics display from the system memory via the north bridge according to the graphics display command of the CPU and processes the display information.

2. The computer graphics display system of claim 1, wherein the memory bridge further contains a south bridge connected to the north bridge for controlling I/O interfaces.

3. The computer graphics display system of claim 2, wherein the south bridge and the north bridge are coupled via a high-speed data interface.

4. The computer graphics display system of claim 1, wherein the GPU contains a priority arbitrating circuit and a priority processing circuit for arbitrating and sorting data in the system memory.

5. The computer graphics display system of claim 4, wherein the priority setting is done by attributing a value to a priority ID.

6. The computer graphics display system of claim 4, wherein the priority setting is done by protocol negotiation.

7. The computer graphics display system of claim 1, wherein the north bridge further contrains a priority arbitrating circuit and a priority processing circuit for arbitrating and sorting data in the system memory.

8. The computer graphics display system of claim 1, wherein the north bridge controls high-speed bus data transmitted therein.
